(19) United States
(12) Patent Application Publication
(10) Pub. No.: US 2010/0069011 A1
(43) Pub. Date: Mar. 18, 2010

(54) Methods and Apparatus For Self-Jamming Suppression In A Radio Frequency Identification (RFID) Reader

(75) Inventors: John C. Carrick, Wakefield, MA (US); Robert R. Herold, Carlisle, MA (US); Sri Krishna, Acton, MA (US); Matthew Reynolds, Durham, NC (US); Yael G. Maguire, Somerville, MA (US); Ravikanth Pappu, Cambridge, MA (US)

Correspondence Address: CHOATE, HALL & STEWART LLP, TWO INTERNATIONAL PLACE, BOSTON, MA, 02110, US

(73) Assignee: THINGMAGIC, INC., Cambridge, MA (US)

(21) Appl. No.: 12/595,109

(22) PCT Filed: Apr. 21, 2008
(86) PCT No.: PCT/US08/61036

§ 371 Date: Oct. 8, 2009

Related U.S. Application Data
(60) Provisional application No. 60/912,871, filed on Apr. 19, 2007.

(51) Int. Cl. H04B 15/00; H04Q 5/22

(52) U.S. Cl. 455/63.1; 340/10.1

(57) ABSTRACT

A circuit for transmitter-receiver isolation that is useful in a monostatic (combined transmitting and receiving) antenna configuration is shown and described. In addition, methods and systems are shown for automatically adjusting the circuit in response to changes in antenna configuration, external signal reflectors, and jamming energy (e.g., self jammer energy) by adjusting the circuit to tune out these sources of jammer energy to yield an increase in RFID reader receiver sensitivity when compared to measurements of the receiver sensitivity when the jammer energy is not present.

### RELATED APPLICATION

This application is related to and claims priority to the following U.S. provisional application, which is incorporated by reference in its entirety: “METHODS AND APPARATUS FOR JAMMING SUPPRESSION IN AN RFID READER,” U.S. Provisional Application No. 60/912,871, filed Apr. 19, 2007.

### FIELD OF THE INVENTION

The present disclosure relates generally to a radio frequency identification (RFID) reader. More specifically, it relates to systems and methods for suppressing a jamming signal coupled from a transmitter to a receiver of an RFID reader.

### BACKGROUND OF THE INVENTION

Passive RFID reader systems present design challenges because the reader's transmitter and receiver must be simultaneously active. This is because the reader's transmitted signal is used to power the tag, and this power must remain available for the tag to be powered up when responding to the reader's commands. An RFID reader, in some cases, receives a weak reply signal from a passive tag while simultaneously transmitting a strong signal that provides power to the tags in its vicinity, as well as communicating commands to those tags to perform various functions.

This simultaneous transmission and reception poses a particular challenge for the receiver section of the RFID reader. That is, some of the transmitter's energy is inevitably present at the receiver's input. The unwanted energy coupled from the RFID reader's transmitter into the RFID reader receiver input is referred to herein as a self-jammer signal.

Self-jammer signals are detrimental to the performance of the RFID reader's receiver for several reasons. Because most, if not all, passive RFID reader receivers are designed according to the homodyne (also called zero-IF or direct conversion) architecture, the self-jammer signal mixes with the receiver's local oscillator to form an unwanted baseband response, including a DC offset signal, at the output of the receiver's demodulator. This baseband response causes many problems.

### SUMMARY OF THE INVENTION

A circuit for transmitter-receiver isolation that is useful in a monostatic (combined transmitting and receiving) antenna configuration is shown and described. In addition, methods and systems are shown for automatically adjusting the circuit in response to changes in antenna configuration, external signal reflectors, and jamming energy (e.g., self-jammer energy) by adjusting the circuit to reduce these sources of jammer energy to yield an increase in RFID reader receiver sensitivity when compared to measurements of the receiver sensitivity when the jammer energy is not reduced.

Various features and advantages may be obtained by practicing that which is disclosed herein. For example, a means to automatically sense the self-jammer energy and to adjust the circuit to reduce the self-jammer energy to a minimum can be realized.

Also, changes in the RFID reader's operating frequency can be monitored so the transmitter-receiver isolation circuit may be “retuned” to optimally tune out the self-jammer energy. In addition, signals at the input of the receiver's demodulator or mixer can be monitored. In response to the monitored signals, the transmitter-receiver isolation circuit is “retuned” to minimize the radio frequency (RF) energy due to the self jammer that is present at the input of the receiver's demodulator or mixer. Also, signals at the output of the receiver's demodulator or mixer are monitored and used to “retune” the transmitter-receiver isolation circuit to minimize the DC offset at the output of the receiver's demodulator or mixer caused by the self-jammer energy multiplying against the reader's local oscillator.

Also, signals at the output of the receiver's demodulator or mixer are measured and used to retune the transmitter-receiver isolation circuit to minimize the baseband noise caused by the self-jammer energy multiplying against the reader's local oscillator. In addition, certain aspects of this disclosure respond to changes in the electromagnetic environment surrounding the reader's antenna, for example caused by a reflective object being placed in front of the antenna, by detecting the increase in the self-jammer energy reflected back into the reader and retuning the transmitter-receiver isolation circuit in response.

The improved transmitter-receiver isolation circuitry is provided without using a Cartesian or polar modulator to modify the local oscillator signal and thus without materially increasing the cost or complexity of the RFID reader. In some embodiments, a single directional coupler is used to reduce the jamming energy in the RFID reader. In other embodiments, the circuit for reducing the self-jammer energy is integrated onto the same substrate as an integrated circuit containing other functions of an integrated RFID reader. In a further embodiment, the circuit for reducing the self-jammer energy does not substantially increase the power consumption of integrated circuit containing the other functions of the integrated RFID reader.

In one aspect the present application features a method for suppressing jamming signal coupled from a transmitter to a receiver of a RFID reader. The method includes measuring a power level of the jamming signal in a receive path of the RFID reader. The RFID reader is in communication with a directional coupler. A processor retrieves one or more parameters corresponding to the measured power level. The retrieved parameters are substantially optimized to reduce the measured power level of the jamming signal. The processor changes the impedance of a circuit in communication with the directional coupler.

In one embodiment, the method includes estimating an operating frequency of the RFID reader. In another embodiment, the one or more parameters are optimized for one or more frequencies. In still other embodiments, the optimization is based on one of a measurement of the jamming signal from a power detector, a measurement of a noise floor on a receive path, a measurement of RF power on a receive path and one or more direct current components of a homodyne receiver. In yet another embodiment, the homodyne receiver is in communication with the directional coupler. In one embodiment, the method includes storing the one or more parameters for each of the one or more frequencies. In another embodiment, the impedance is changed by adjusting one of a variable phase shifter or an attenuation factor of a variable attenuator. In yet another embodiment, the processor receives one or more signals from a power detector and/or transmits one or more signals to the power detector, the circuit and the directional coupler.

In another aspect a system for suppressing jamming signal coupled from a transmitter to a receiver of a RFID reader is described. The system includes a processor, a controllable impedance circuit and a directional coupler. The processor communicates with a receive path modulator of the RFID reader to receive a power measurement and executes instructions to retrieve one or more parameters corresponding to the measured power. The controllable impedance circuit receives and responds to a command from the processor to adjust one or more attributes of the impedance circuit. In one embodiment, the command is based on the parameters retrieved by the processor. The directional coupler is in communication with the impedance circuit and a performance parameter of the directional coupler changes responsive to a change in the one or more attributes of the controllable impedance circuit.

In one embodiment, the processor may include one or more of the following: a dedicated logic hardware, a state machine, a microcontroller, a digital signal processor, (DSP), an application specific integrated circuit (ASIC), a field programmable gate array (FPGA) and software. In another embodiment, the system includes one or more antenna elements and a multi-way switch. In still another embodiment, the controllable impedance circuit may include one or more of the following: a variable attenuator, a variable phase shifter, a variable inductor, a variable capacitor and a reflective load. In yet another embodiment, the variable phase shifter may include a quadrature hybrid coupler. In one embodiment, the system includes a power detector measuring a jamming signal due to a transmitter of the RFID reader. In another embodiment, the retrieved parameters are optimized based on one or more of: a noise floor on a receive path, a measurement of RF power on a receive path and one or more direct current components of a homodyne receiver. In still another embodiment, the DC components arise due to a transmitter of the RFID reader. In yet another embodiment, the system further includes a feedback circuit between the processor and the controllable impedance circuit.

### BRIEF DESCRIPTION OF THE DRAWINGS

These and other aspects of this invention will be readily apparent from the detailed description below and the appended drawings, which are meant to illustrate and not to limit the invention, and in which:

FIG. 1 is a block diagram of an embodiment of an isolation circuit;

FIG. 2 is a block diagram of another embodiment of an isolation circuit;

FIG. 3 is a block diagram of a embodiment of a controllable impedance circuit;

FIG. 4 is a block diagram of an embodiment of an RFID reader transmit and receive interface;

FIG. 5 is a flow chart of an embodiment of a method of finding a substantially optimal point on a curve; and

FIG. 6 is a flow chart of an embodiment of a method of executing an algorithm each time an RFID reader hops to a different frequency.

### DETAILED DESCRIPTION

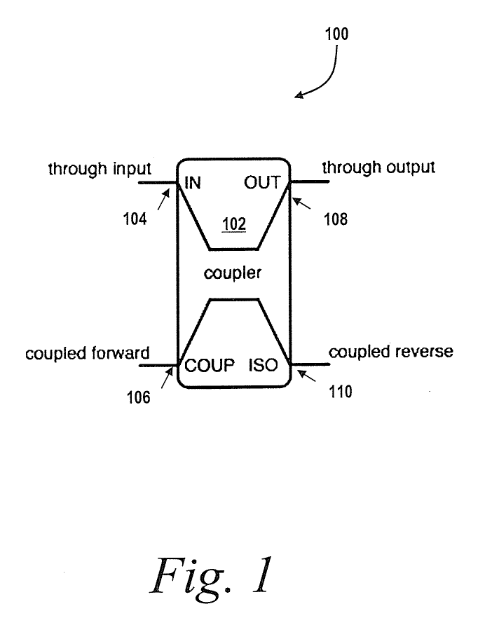

Referring now to FIG. 1, an isolation circuit 100 is shown and described. In one embodiment, the isolation circuit 100 is a transmitter-receiver isolation circuit that is based on a single directional coupler 102. A directional coupler is a device that preferentially couples signals to different output ports depending on the direction of travel of signals through the main path of the directional coupler. In a specific embodiment, the isolation circuit 100 includes a directional coupler with the coupling among the two output ports relative to the direction of travel of signals along the main path of the directional coupler.

In a well known configuration of an RFID reader, a directional coupler's “through input” port 104 is typically connected to the RFID reader's transmitter. The “through output” port 108 is typically connected to an antenna (not shown). The “coupled forward” port 106 is typically terminated in a matched load resistance (not shown), for example a 50-ohm resistor, or a 50-ohm attenuator connected to a forward power sensor that measures transmitter power. The “coupled reverse” port 110 is then connected to the reader's receiver input port.

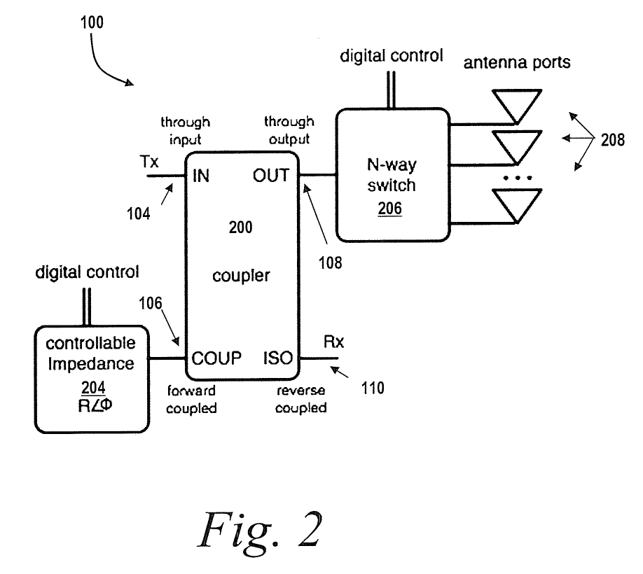

With reference to FIG. 2, another embodiment of an isolation circuit 100 is shown and described. The circuit includes a directional coupler 200, a configurable impedance circuit 204, a switch 206, and one or more antennas 208. The directional coupler 200 communicates with the configurable impedance circuit 204 via the coupled forward port 106. The switch 206 communicates with the directional coupler 200 via the through output port 108. The switch also receives input from a processing module (not shown) to switch among the plurality of antennas 208.

In one embodiment, the directional coupler 200 is a 10 dB directional coupler part number XC0900A-10 manufactured by Anaren Microwave Inc. of East Syracuse, N.Y. In other embodiments other directional couplers having other coupling parameters are used. For example, a circulator, a waveguide, transmission line, or lumped-element hybrid network, or a 6 port coupler and above can also be used for the coupler 200.

The switch 206 can be an “N-way” switch, where N corresponds to the number of antenna elements 208 in communication with the switch 206. In other embodiments, N is fewer or greater than the number of antenna elements 208 communicating with the switch 206 (e.g., if one of the antenna elements 208 includes an array of elements). In one embodiment, the switch is part number MASW-007813, made by MA/COM of Burlington, Mass.

The antennas 208 can be any type of an antenna element. For example, the antenna elements 208 can be, but are not limited to, patch antennas, waveguide slot antennas, dipole antennas, and the like. Each antenna element 208 can be the same type of elements. Alternatively, two or more different types of antenna elements 208 can be used. In some embodiments, one or more of the antenna elements 208 includes a plurality of antenna elements (i.e., an array of antenna elements). In some embodiments, the antenna elements 208 are multiplexed.

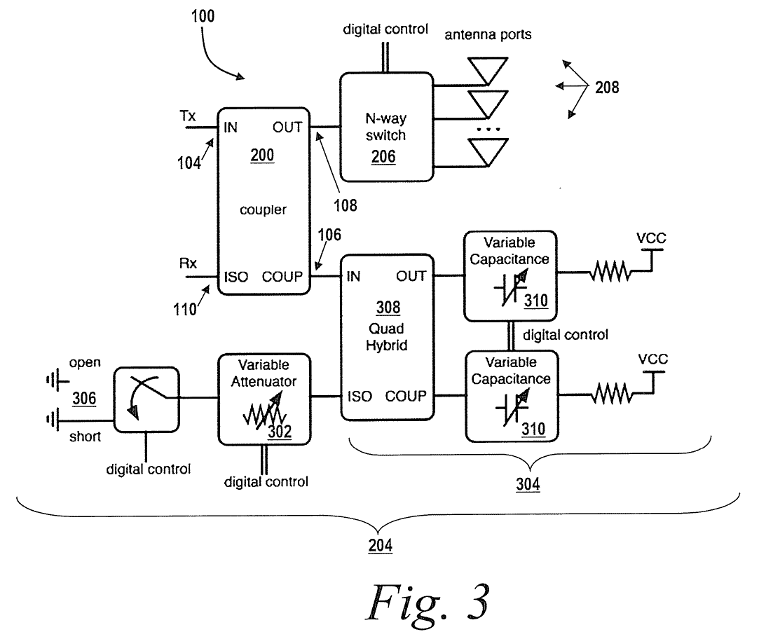

In one embodiment, the controllable impedance circuit 204 includes a variable attenuator, a variable phase shifter, and a reflective load such as an open or short circuit, which are described in more detail below with reference to FIG. 3. In other embodiments, additional or fewer components are included in the controllable impedance circuit 204.

As an operational overview and in one embodiment of operation, the controllable impedance circuit 204 is connected to the forward-coupled port 106 of the directional coupler so that the signal at the reverse-coupled port 110 can be affected by a reflection from the forward-coupled port 106. Thus a sampled portion of the transmitter's signal, varied in magnitude and phase by the controllable impedance circuit 204, can be reflected back into the coupler 200, which then reduces the amount of self-jammer energy present at the reverse-coupled port 110. Since the reader's receiver is connected to the reverse-coupled port 110, the self jammer energy at the receiver input port can be controlled by adjusting the controllable impedance circuit 204.

With reference to FIG. 3, an embodiment of the controllable impedance circuit 204 is shown and described. The controllable impedance circuit 204 includes a variable attenuator 302, a variable phase shifter 304, and a reflective load 306 such as an open or short circuit.

In one embodiment, the variable attenuator 302 consists of a PIN diode attenuator, a gallium arsenide or silicon monolithic switched resistive or capacitive attenuator, or any other variable attenuator. In a specific embodiment, the variable attenuator 302 consists of a switched monolithic attenuator part number DAT-15R5-PP available from Mini-Circuits Corp. of Brooklyn, N.Y. In another embodiment the variable attenuator 302 consists of a pair of PIN diodes, such as part number SMP-1304-011 available from Skyworks Solutions Inc. of Burlington, Mass., connected back-to-back in a series attenuator configuration.

In operation, the variable attenuator 302 communicates with a digital control device, described in more detail below, and receives commands from the digital control device. These commands cause the attenuator 302 to vary within a range of attenuation settings. For example, the attenuator 302 can have a granularity or step size of 0.5 dB and an attenuation range of 0 to 15 dB or greater. There is a tradeoff between level of self-jammer minimization and step size.

In one embodiment, the variable phase shifter 304 consists of a quadrature hybrid 308 connected to a pair of switched capacitor banks 310 implemented with either discrete components or an integrated circuit. In other embodiments the variable phase shifter 304 consists of a quadrature hybrid 308 connected to a pair of varactor diodes. In one embodiment the phase shifter consists of a quadrature hybrid 308 such as the XC0900P-03S hybrid coupler made by Anaren Microwave Inc. of East Syracuse, N.Y. In another embodiment, 0 degree and 90 degree ports of the hybrid coupler 308 are each connected to a separate array of monolithic capacitors with values 0.5 pF, 1.0 pF, 2.2 pF, and 4.7 pF or another substantially binary weighted series of capacitances and switched by a gallium arsenide switch such as part number MASWSS0064 available from M/A-Com Inc. of Burlington, Mass. In yet another embodiment these capacitances are implemented with transmission lines of varying lengths. In a further embodiment, the phase shifter 304 is implemented using inductances.

In operation, the variable phase shifter 304 communicates with a digital control device, described in more detail below, and receives commands from the digital control device. These commands cause the phase shifter 304 to vary among a variety of phase settings. For example, in one embodiment the phase shifter 304 is capable of approximately 200 degrees of controlled phase shift across the 902-928 MHz band. In another embodiment, the phase shifter 304 consists of 3 series transmission line sections and 2 transmission line stubs with each of those three series sections being approximately one quarter wavelength long, and with variable reactances (e.g. switched capacitors) on the ends of the two transmission line stubs.

In one embodiment, reflective load 306 consists of a switch that presents either a short circuit or an open circuit. In one embodiment this switch consists of a gallium arsenide switch part number MASWSS0192 available from M/A-Com Inc. of Burlington, Mass. This switch presents a 180-degree phase shift due to the change in reflectance between the open and short circuit. When this phase shift is added to the approximately 200 degrees of phase shift available from the previously described phase shifter 304, an aggregate phase shift of greater than 360 degrees is available, which enables the controlled impedance to be placed at any rotation on a Smith Chart, which is also called the plane of complex impedance. In another embodiment, the reflective load 306 includes an open circuited transmission line stub preceded by a diode (PIN or otherwise) to yield a short circuit. Additionally, switched values of inductance and capacitance, as in a ladder network, can also be used.

In operation, the reflective load 306 communicates with a digital control device, described in more detail below, and receives commands from the digital control device. These commands cause the reflective load to vary between the open circuit configuration and the closed circuit configuration.

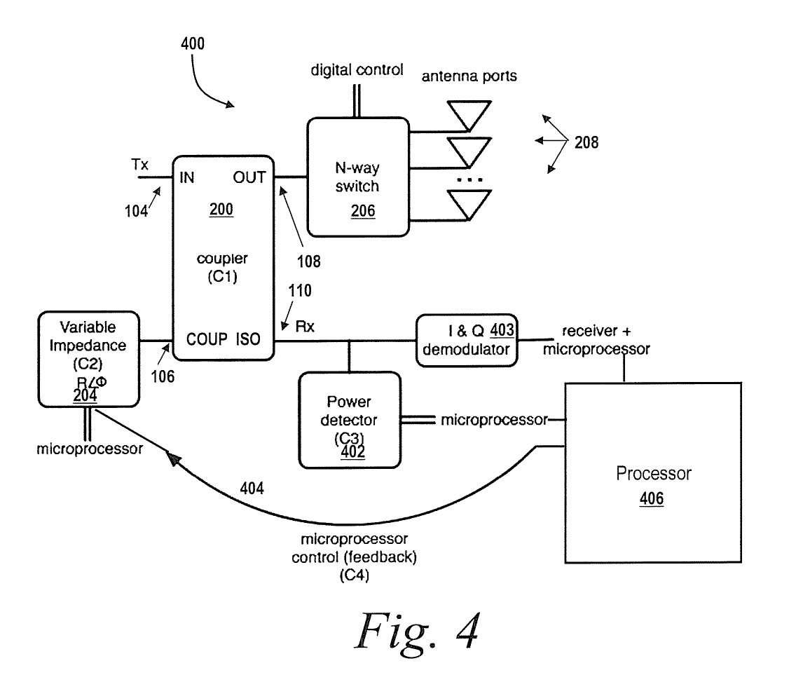

With reference to FIG. 4, one or more aspects of the disclosure are incorporated into the front-end circuitry of an RFID reader 400. The directional coupler 200 is shown as C1. The variable impedance section 304 is shown as C2. An optional RF power detector 402 at the input of the receiver demodulator 403 is shown as C3. The feedback path 404 C4 is shown wherein the output of the receiver demodulator 403 and/or the RF power detector 402 is sampled and fed to a processor 406 implementing a control method described below in more detail.

In one embodiment, the processor 406 is a microcontroller, microprocessor, or digital signal processor (DSP). In another embodiment, the processor 406 is a field programmable gate array (FPGA). In another embodiment, one or more application specific integrated circuits (ASIC) are used. Also, various microprocessors can be used in some embodiments. In other embodiments, multiple DSPs are used along or in combination with various numbers of FPGAs. Similarly, multiple FPGAs can be used. In one specific embodiment, the processor 406 is a BLACKFIN DSP processor manufactured by Analog Devices, Inc. of Norwood, Mass. In another embodiment, processor 406 is a TI TMS320VC5502 digital signal processor manufactured by Texas Instruments Inc. of Dallas Tex.

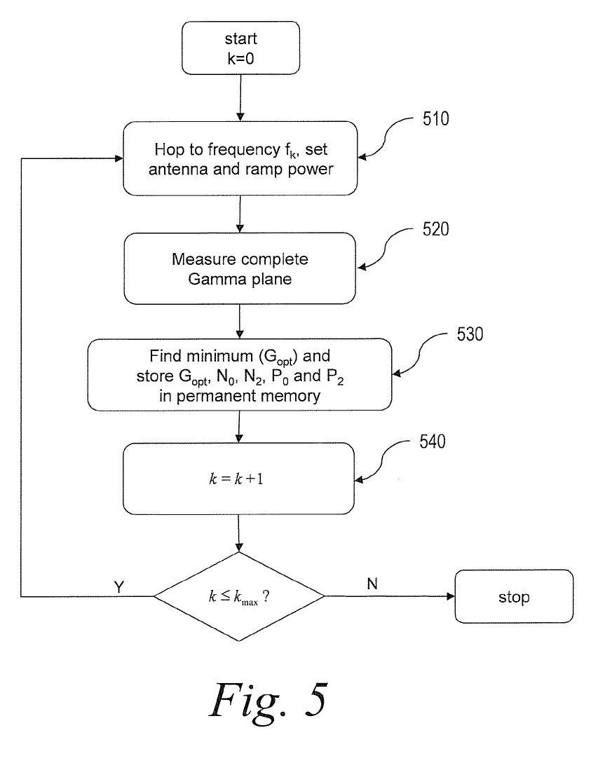

In operation, the feedback from the power detector 402 and/or demodulator 403 are presented to the processor and used to automatically adjust the controllable circuit 204 to compensate for changes to the self-jammer level as the antenna, operating frequency, or local electromagnetic environment is changed. One method for adjusting the variable impedance is described below with reference to FIG. 5. This method may be implemented in dedicated logic hardware, in a state machine, in a microcontroller, or in software operating on a microprocessor.

With reference to FIG. 5, a method of finding a substantially optimal point on a curve is shown and described. This substantially optimal point corresponds to a configuration of variable impedance 204 (of FIG. 4) that reduces the self-jammer induced baseband noise and/or DC offset as observed at the power detector 402 and/or demodulator 403. For the parameters shown above, the function curve fit is N(G)=N₀+N₂|Gₒₚₜ−G|², N₂>0 and N(G)≦N₀+12 dB, else N(G)=N₀+12 dB, where N is a curve fit function of the baseband noise level that best fits the measured data. The value of 12 dB is an arbitrary observed value of elevated noise level over the noise level when the self-jammer is not present; other elevated noise level values may be selected based on the performance of the receiver. In the previous equation, the G-Plane is a representation of the input impedance or load of a system. G=(Z_{L}−R₀)/(Z_{L}+R₀) where R₀ is the source impedance and Z_{L} is the complex load impedance.

In operation, the method includes frequency hopping (step 510) to a frequency Fₖ, setting the antenna switch 204 and ramping the transmitter power from a low level to a nominal output power. At this setting, the components of the reader cooperate to measure (step 520) the noise elevation N(G) and power detector 402 output P(G) across the complete gamma plane. Next, a minimum (i.e., Gₒₚₜ) is found (step 530) and parameters Gₒₚₜ, N₀, N₂, P₀ and P₂ are stored in memory by the processor, where P is a curve fit function of the power detection that best fits the measured data. The frequency is adjusted to a new value (step 540) and the measurements are completed and stored again. This continues until the frequency reaches a maximum or all desired frequencies have been measured. In another embodiment, instead of incrementing the frequency it is decremented until it reaches a minimum value. Also, in other embodiments, the frequency is hopped and the order may be pseudo random, incremented/decremented as per local regulations.

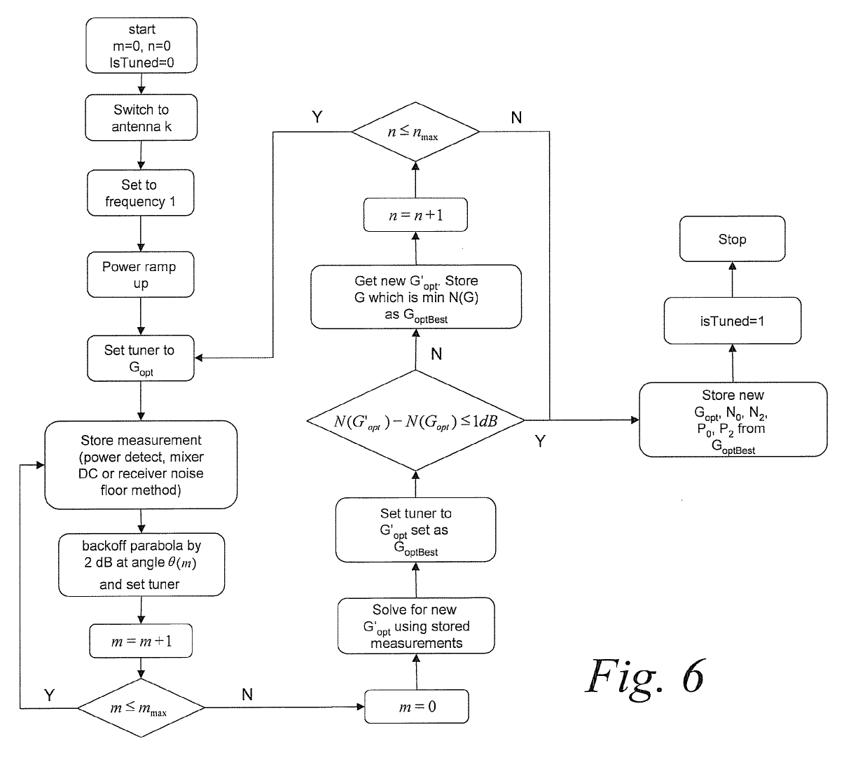

With reference to FIG. 6, an embodiment of a method for executing an algorithm to optimize the setting of the controllable impedance circuit 204 each time the reader hops frequency is shown and described. The m loop provides fine grain setting of tuner Gₒₚₜ. The n loop provides search across wider range when needed. During the execution of the m loop, data is collected at some number, in one embodiment four or more points, in the vicinity of the current guess of the optimum tune point. This data is expected to be in a parabolic portion of the tuner noise response. This is by virtue of having backed away from the current guess by 2 dB as determined by the current parameters that model the parabolic behavior. After collection of these data, they are used to calculate an updated estimate of for the parabolic behavior, and the minimum G for this new estimate is used as the new Gₒₚₜ. With four data points, direct calculation may be used to find Gₒₚₜ, N0, and N2. For the case where more than four data points are collected various nonlinear estimation techniques may be used (such as the Levenberg-Marquardt minimization algorithm, or another estimation method). This new estimate is then verified by measurement and if it is within a threshold of the previously determined noise minimums, it is assumed to be correct and the algorithm shown in the flow chart terminates. In one embodiment, the threshold is taken as 1 dB. If the new Gₒₚₜ estimate is not within the threshold, then it is possible that the optimum tuning point of the impedance circuit 204 has moved far way and the collected data is in the flat portions of the measurement surface. In this case a more global search across a wider range of the tuning range is undertaken and data is measured at Nₘₐₓ new G values. After data collection of these Nₘₐₓ new values the measured noise values are scanned for a minimum and this new minimum is assumed to be the new estimate of the optimum tuning.

Using the circuitry and algorithms described above, there are multiple methods to automatically adjust the configurable impedance circuit 204 to compensate for changes to the self-jammer level. A first method is to examine the receive path noise floor by examining noise power in the baseband signals. This is a direct method in the sense that it is a direct measure of one of the effects of the self-jammer noise that the tuner is trying to reduce. The tuning circuitry 204 is passive with respect to the RF signal path, so it does not contribute significant noise on its own, or increase the receiver noise floor. The minimization of the receive path noise floor therefore implies that the controlled impedance is properly adjusted. This noise floor may be measured by digitizing the demodulator 403 output with the reader's analog to digital converter(s) (not shown) and measuring the amount of noise present in a frequency range free of tag responses.

A second method of detecting optimal adjustment of the controlled impedance circuit 204 is by examination of the RF power entering the receive signal path. When there are no interfering signals other than the self jammer energy, the minimization of total energy present at the demodulator 403 input port represents an optimal adjustment of the controlled impedance. It has been observed that the substantial minimization of RF power on the receive path coincides with minimum receive path noise floor. When there are interfering signals present, it is usually the case that the amplitude of the interfering signal is small compared with the self-jammer signal. Thus a minimization of RF power at the input of the demodulator 403 still provides an indication of correct adjustment. However, when unusually large interferers are present the detected energy on the receive path provides only weak feedback on the quality of tuning because the self-jammer energy is dominated by the large interfering signal. This is because a wideband RF power measurement at the input of the receiver responds both to the self-jammer as well as any external interferers that may be present.

A third method of controlled impedance circuit 204 optimization is to examine the DC output component of a homodyne receiver's I/Q demodulator 403. For an ideal I/Q demodulator, when the DC component of both the I and Q demodulator outputs is zero (or zero differential volts when considering a differential demodulator output), the tuning is substantially optimum. It has been observed that the minimization or receive noise floor corresponds with near-zero I and Q mixer DC voltage outputs. For a non-ideal demodulator, the controlled impedance circuit 204 adjustment is optimal when the demodulator's output DC component is the same as the inherent DC offset caused by the demodulator itself, for example due to any DC imbalance in the demodulator's internal mixer cells. In one embodiment, a monolithic demodulator, part number LT5575 manufactured by Linear Technology Inc. of Milpitas, Calif., has low inherent offset due to its monolithic construction. This offset and other DC offset sources are in general small compared with the DC values due to the self-jammer energy being measured, and can often be neglected. Alternately the offset may be included as an overall measurement offset. This offset can be stored in a non-volatile memory, for example during a factory calibration, and can be subtracted from measured values obtained during controlled impedance adjustment if this third method of detecting optimal adjustment is employed.

This third method provides two signed numbers (sign+magnitude) to assist in locating the optimal adjustment. The first and second methods provide a single unsigned scalar, the minimum of which constitutes best adjustment. For the previous two methods, direction of adjustment toward an optimum is determined by making small steps in one or more of the controlled impedance circuit 204 parameters (attenuation, phase, and reflection switch) and examining the derivative of the measure. With the third method, the signed numbers, and the fact that there are separate numbers for the demodulator's I mixer and Q mixer outputs provide additional information useful for the controlled impedance adjustment. Also in the vicinity of the optimum tuner setting, the I and Q mixer responses are approximately orthogonal (i.e. movement in the correct direction only affects I, and movement in the perpendicular direction only effects Q). Mixer tuning can be achieved by simply following the correct direction for first one mixer to adjust its output to zero and then adjust in a perpendicular direction to adjust the other output also to zero. This doesn't require more complex nonlinear optimizations of the previous block diagram, and can be achieved by simply following two gradients to zero. Alternatively, as with FIG. 5 and FIG. 6, the tuner may be adjusted across all settings to find setting that brings the I mixer and Q mixer outputs to zero, thus achieving the tuned condition.

In one embodiment, the RFID reader system 400 may consist of one or more transmitters and one or more receivers operating simultaneously. In another embodiment, the antenna switch 206 may be replaced by the one or more receivers. In still another embodiment, the operations described herein maybe performed for each of the one or more receivers using a common processor 406. In yet another embodiment, a separate processor may be used for each of the one or more receivers.

In view of the structure and functions of the systems and methods described here, the present solution provides a method and system for suppressing radio frequency (RF) power coupled to the receiver port of an RFID reader from the transmitter port of the same RFID reader. Having described certain embodiments of methods and systems for such suppression, it will now become apparent to one of skill in the art that other embodiments incorporating the concepts may be used without departing from the scope of the disclosure. Therefore, the invention should not be limited to certain embodiments, but rather should be limited only by the spirit and scope of the following claims:

What is claimed is:

1. A method for suppressing a jamming signal coupled from a transmitter of a Radio Frequency Identification (RFID) reader to a receiver of the RFID reader, the method comprising:
measuring a power level of the jamming signal in a receive path of the RFID reader, the RFID reader being in communication with a directional coupler;
retrieving, by a processor, one or more parameters corresponding to the measured power level, the one or more parameters being substantially optimized to reduce the measured power level of the jamming signal; and
changing, by the processor responsive to the one or more parameters, an impedance of a circuit in communication with the directional coupler.

2. The method of claim 1 further comprising estimating an operating frequency of the RFID reader.

3. The method of claim 1 further comprising optimizing the one or more parameters for one or more frequencies.

4. The method of claim 3 wherein the optimizing is based on a measurement of the jamming signal from a power detector.

5. The method of claim 3 wherein the optimizing is based on a measurement of a noise floor on a receive path.

6. The method of claim 3 wherein the optimizing is based on a measurement of a radio frequency (RF) power on a receive path.

7. The method of claim 3 wherein the optimizing is based on one or more direct current (DC) components of a homodyne receiver communicating with the directional coupler.

8. The method of claim 3 further comprising storing the one or more parameters for each of the one or more frequencies.

9. The method of claim 1 wherein the changing includes adjusting a variable phase shifter.

10. The method of claim 1 wherein the changing includes adjusting an attenuation factor of a variable attenuator.

11. The method of claim 1 further comprising receiving, by the processor, one or more signals from a power detector.

12. The method of claim 1 further comprising transmitting, by the processor, one or more signals to one or more of a power detector, a variable impedance circuit, and a directional coupler.

13. A system for suppressing jamming signal coupled from a transmitter of a Radio Frequency Identification (RFID) reader to a receiver of the RFD reader, the system comprising:
a processor in communication with a receive path modulator of the RFID reader, the processor receiving a power measurement from the receive path modulator and executing instructions to retrieve one or more parameters corresponding to the measured power;
a controllable impedance circuit, in communication with the processor, receiving and responding to a command based on the retrieved parameters from the processor to adjust one or more attributes of the controllable impedance circuit; and
a directional coupler in communication with the controllable impedance circuit, the directional coupler having a performance parameter that changes responsive to a change in the one or more attributes of the controllable impedance circuit.

14. The system of claim 13 wherein the processor includes one or more of a dedicated logic hardware, a state machine, a microcontroller, a digital signal processor (DSP), an application specific integrated circuit (ASIC), a field programmable gate array (FPGA) and a software.

15. The system of claim 13 further comprising one or more antenna elements and a multi-way (N-way) switch.

16. The system of claim 13 wherein the controllable impedance circuit comprises one or more of a variable attenuator, a variable phase shifter, a variable inductor, a variable capacitor and a reflective load.

17. The system of claim 13 wherein the variable phase shifter further comprises a quadrature hybrid coupler.

18. The system of claim 13 wherein a power detector measures a jamming signal due to a transmitter of the RFID reader.

19. The system of claim 13 wherein the retrieved parameters are optimized based on a measure of a noise floor of a receive path of the RFID reader.

20. The system of claim 13 wherein the retrieved parameters are optimized based on a measure of one or more direct current (DC) components from a homodyne receiver, the one or more DC components arising due to a transmitter of the RFID reader.

21. The system of claim 13 further comprising a feedback circuit between the processor and the controllable impedance circuit.
